(19) United States
(12) Patent Application Publication
(10) Pub. No.: US 2026/0169876 A1
(43) Pub. Date: Jun. 18, 2026

(54) PERFORMING FUZZ TESTING ON INTER-PROCESSOR COMMUNICATIONS

(71) Applicant: Robert Bosch GmbH, Stuttgart (DE)

(72) Inventors: Zachariah T. Pelletier, North Charleston, SC (US); Timothy S. Arntson, Ypsilanti, MI (US); Joshua P. Beck, Detroit, MI (US)

(21) Appl. No.: 18/986,300

(22) Filed: Dec. 18, 2024

(51) Int. Cl. G06F 11/26

(52) U.S. Cl. CPC G06F 11/261

(57) ABSTRACT

A system for performing fuzz testing on inter-processor communications. In one example, the system includes a first electronic processor, a second electronic processor configured to communicate with the first electronic processor, and a testing device, connected to the first electronic processor and the second electronic processor. The testing device includes a third electronic processor. The third electronic processor is configured to intercept messages from the first electronic processor. The messages are sent by the first electronic processor to the second electronic processor. The third electronic processor is also configured to determine, based on the messages, baseline communications data representing standard messages sent to the second electronic processor from the first electronic processor, based on the baseline communications data, generate a fuzzed message, and send the fuzzed message to the second electronic processor.

### SUMMARY

Implementations described herein provide, among other things, systems and methods for performing fuzz testing against hardware protocols used for inter-processor communication (IPC). Among other things, a fuzz-testing framework that includes two primary components 1) a protocol-analyzer tool and 2) a fuzz testing injection tool is described below. The protocol-analyzer may be utilized to baseline communication messages across hardware traces to create a profile used to send fuzzed messages from a fuzz test harness through either a guided or non-guided stateful connection fuzz session. The methodology provides, among other things, the ability to focus on baseline communication that is non-standard for the Device under Test (DuT). In some implementations described herein, the DuT is a tapped hardware trace.

The systems and methods described herein may be used to uncover security vulnerabilities pertaining to chip-to-chip communication on a printed circuit board (PCB), and potentially illuminate previously undiscovered issues with the robustness of the complete working system implemented on the PCB. Current industry-standard processes for testing chip-to-chip or inter-processor communications require a human tester to manually capture and analyze traffic between chips to learn how to manipulate data to test the design of the PCB. Implementations described herein allow, among other things, fuzz testing of inter-processor communications to be performed automatically and provide more testing coverage of the protocol and target chip, both in breadth and depth of the protocol stack implementation.

When performing fuzz testing against the DuT (Device under Test), metrics may be established to determine what message data may be interpreted as anomalous behavior compared to what message data represents baseline activity (for example, general or standard communications sent over a DuT during normal operations). Prior to performing the active data injection portion of fuzz testing (sending fuzzed messages), a process known as “baselining” is performed to determine what data traveling across the physical traces between chips or electronic processors is representative of data transmission during normal operating conditions of the overall system (for example, the PCB or the device including the PCB). Baselining and subsequent measuring of message data from the DuT during active fuzzing is achieved by measuring the data signals produced by the chip or processor that corresponds to output based on the chip-to-chip communication protocol that is used for communications between the two chips or processors that are targeted for fuzzing. During active fuzzing (sending fuzzed messages via the tapped trace), anomaly or fuzzed messages are generated according to the chip-to-chip communication protocol using user input data, baseline communication data determined by performing the baselining process, a combination of the foregoing, and, in some cases, other data. The fuzzed messages are injected onto the input communication line of the intended recipient chip or electronic processor via the trace connected to the input communication line. Which trace corresponds to the input communication line and/or what other pre-requisites are necessary to transmit fuzzed messages depends on the protocol utilized to communicate between chips or electronic processors being tested.

One example implementation provides a system for performing fuzz testing on inter-processor communications. The system includes a first electronic processor, a second electronic processor configured to communicate with the first electronic processor, and a testing device connected to the first electronic processor and the second electronic processor. The testing device includes a third electronic processor. The third electronic processor is configured to intercept messages from the first electronic processor. The messages are sent by the first electronic processor to the second electronic processor. The third electronic processor is also configured to determine, based on the messages, baseline communications data representing standard messages sent to the second electronic processor from the first electronic processor, based on the baseline communications data, generate a fuzzed message, and send the fuzzed message to the second electronic processor.

Another example implementation provides a method for performing fuzz testing on inter-processor communications. The method includes intercepting messages from a first electronic processor. The messages are sent by the first electronic processor to a second electronic processor. The method also includes determining, based on the messages, baseline communications data representing standard messages sent to the second electronic processor from the first electronic processor, based on the baseline communications data, generating a fuzzed message, and sending the fuzzed message to the second electronic processor.

### BRIEF DESCRIPTION OF THE DRAWINGS

FIG. 1 is a block diagram of an example system for performing fuzz testing on inter-processor communications, in accordance with some implementations.

FIG. 2 illustrates an example of a PCB, in accordance with some implementations.

FIG. 3A and FIG. 3B illustrate an example of a PCB connected to a testing device, in accordance with some implementations.

FIG. 4 is an example flowchart of a method for performing fuzz testing on inter-processor communications, in accordance with some implementations.

FIG. 5 is an example flowchart of a method for performing fuzz testing on inter-processor communications, in accordance with some implementations.

FIG. 6 is an example flowchart of the functionality performed by protocol analyzer software, in accordance with some implementations.

### DETAILED DESCRIPTION

Before any implementations are explained in detail, it is to be understood that this disclosure is not intended to be limited in its application to the details of construction and the arrangement of components set forth in the following description or illustrated in the following drawings. Implementations are capable of other configurations and of being practiced or of being carried out in various ways.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware and/or hardware. For example, instead of being located within and performed by a single electronic processor, logic and processing described herein may be distributed among multiple electronic processors. Similarly, one or more memory modules and communication channels or networks may be used even if implementations described or illustrated herein have a single such device or element. Also, regardless of how they are combined or divided, hardware and software components may be located on the same computing device or may be distributed among multiple different devices. Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

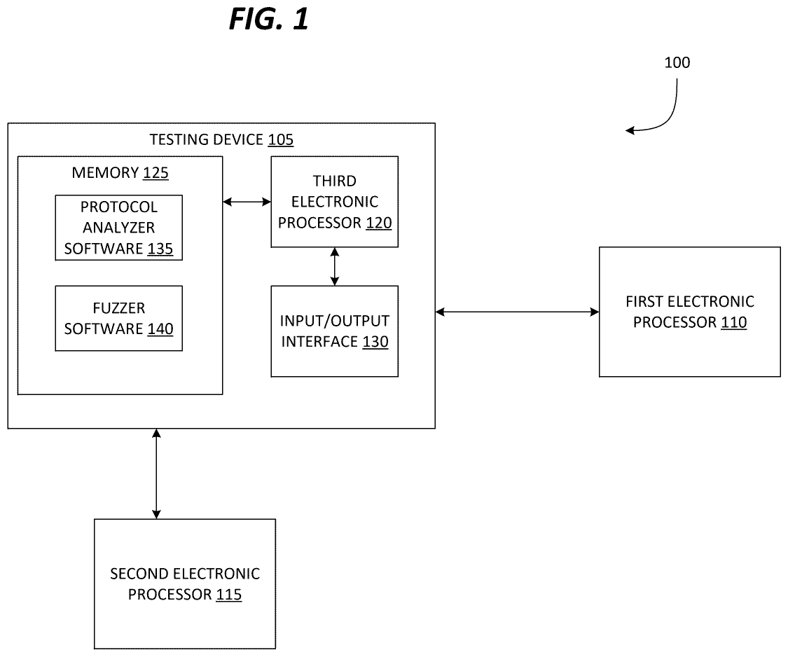

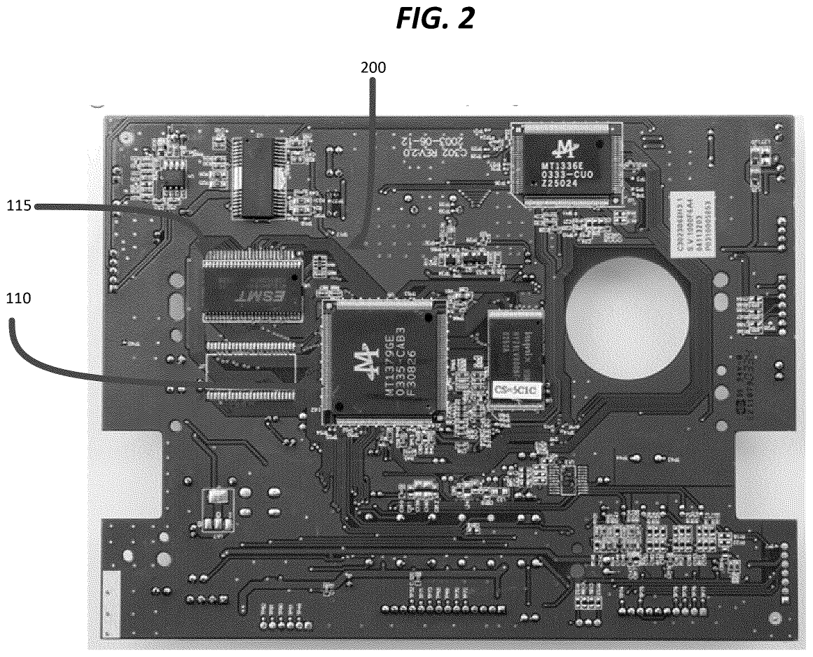

FIG. 1 provides a block diagram of a system 100 for performing fuzz testing on inter-processor communications. In the example shown, the system 100 includes a testing device 105, a first electronic processor 110, and a second electronic processor 115. The first electronic processor 110 and the second electronic processor 115 may be a microprocessor, application specific integrated circuit, a computer chip, etc. The first electronic processor 110 and the second electronic processor 115 may both be included on a PCB and normally connected on the PCB via a hardware trace. For example, FIG. 2 provides an example of a PCB including an example of the first electronic processor 110 and the second electronic processor 115 connected via a hardware trace 200. To test the security of communications between the first electronic processor 110 and the second electronic processor 115, the hardware trace may be physically broken and a shunt inserted. The shunt may allow a testing device (for example, the testing device 105) to intercept communications between the first electronic processor 110 and the second electronic processor 115 and to send communications to the first electronic processor 110 and the second electronic processor 115. In some implementations, the testing device 105 is connected to the first electronic processor 110 and the second electronic processor 115 via one or more wires. The process of breaking a trace, inserting a shunt, and connecting the testing device may be referred to as “tapping the trace” and the broken trace may be referred to as the “tapped trace.” In some implementations, to test the security of communications between the first electronic processor 110 and the second electronic processor 115, multiple traces between the first electronic processor 110 and the second electronic processor 115 are tapped.

The testing device 105 includes a third electronic processor 120 (for example, a microprocessor, application specific integrated circuit, etc.), a memory 125, and a communication interface 130. The memory 125 may be made up of one or more non-transitory computer-readable media. The memory 125 can include combinations of different types of memory, such as read-only memory (“ROM”), random access memory (“RAM”), electrically erasable programmable read-only memory (“EEPROM”), flash memory, or other suitable memory devices. The third electronic processor 120 is coupled to the memory 125 and the communication interface 130. The third electronic processor 120 sends and receives information (for example, from the memory 125 and/or the communication interface 130) and processes the information by executing one or more software instructions or modules, capable of being stored in the memory 125, or another non-transitory computer readable medium. The software can include firmware, one or more applications, program data, filters, rules, one or more program modules, and other executable instructions. The third electronic processor 120 is configured to retrieve from the memory 125 and execute, among other things, software for performing methods as described herein. In the example illustrated, the memory 125 stores, among other things, protocol analyzer software 135 and fuzzer software 140.

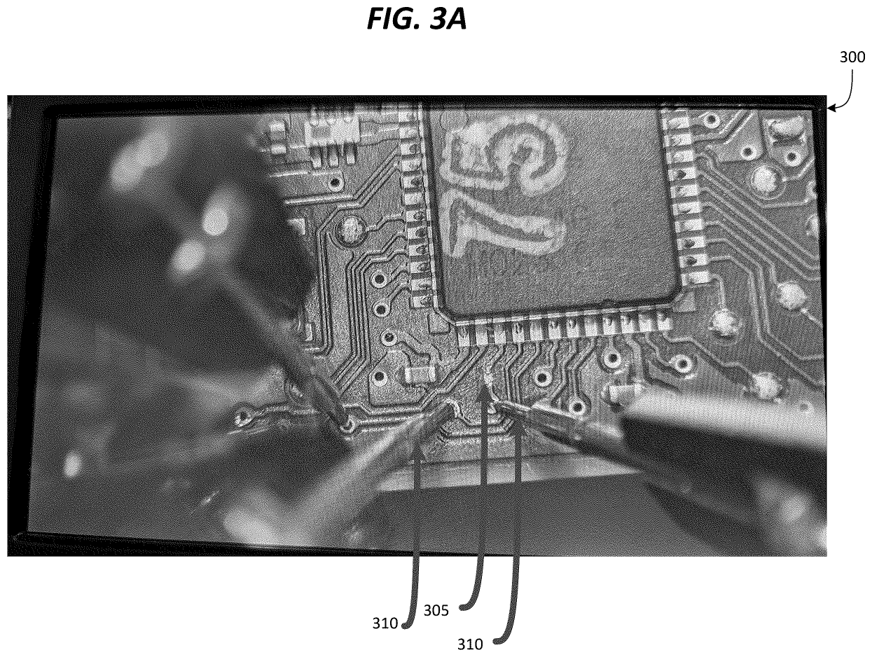

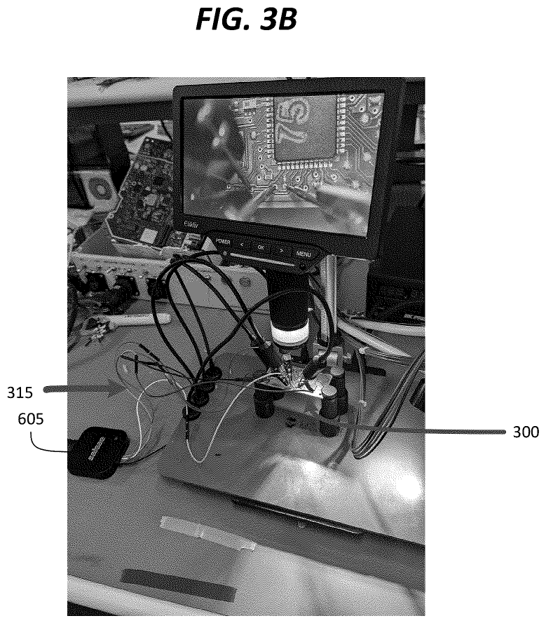

FIG. 3A and FIG. 3B provide an example of a PCB 300 connected to a testing device. In FIG. 3A, the trace is modified or broken at location 305. The pins 310 are attached to wires 315 that connect the PCB 300 to the testing device 105. In FIG. 3B, the PCB 300 is connected to a logic analyzer 605 (described below) included in the testing device 105.

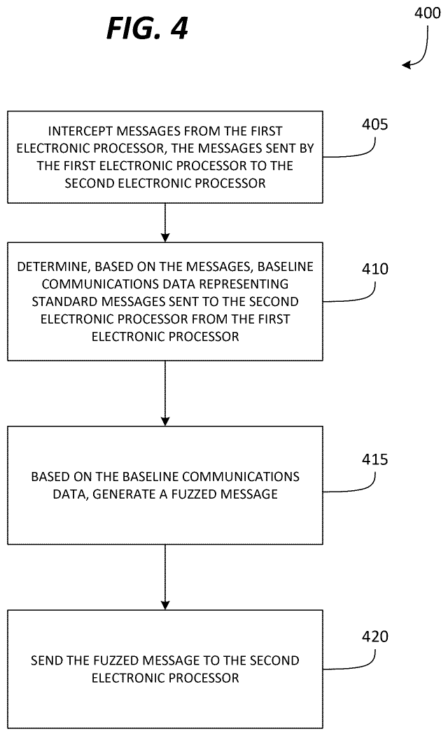

FIG. 4 is an example flowchart of a method 400 for performing fuzz testing on inter-processor communications. In some implementations, the method 400 begins at block 405 when the third electronic processor 120 intercepts messages from the first electronic processor 110. The messages may be sent by the first electronic processor 110 to the second electronic processor 115 when the messages are intercepted by the third electronic processor 120.

At block 410, the third electronic processor 120 determines, based on the messages, baseline communications data representing standard messages sent to the second electronic processor 115 from the first electronic processor 110.

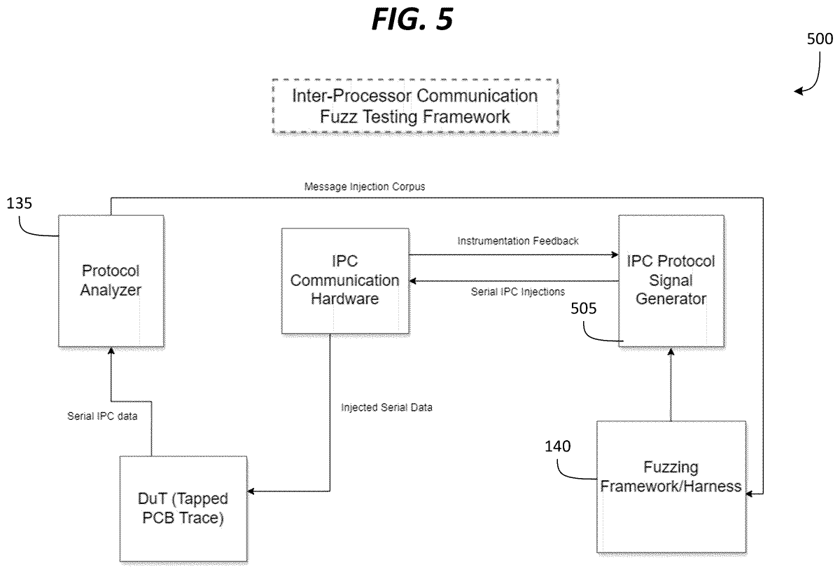

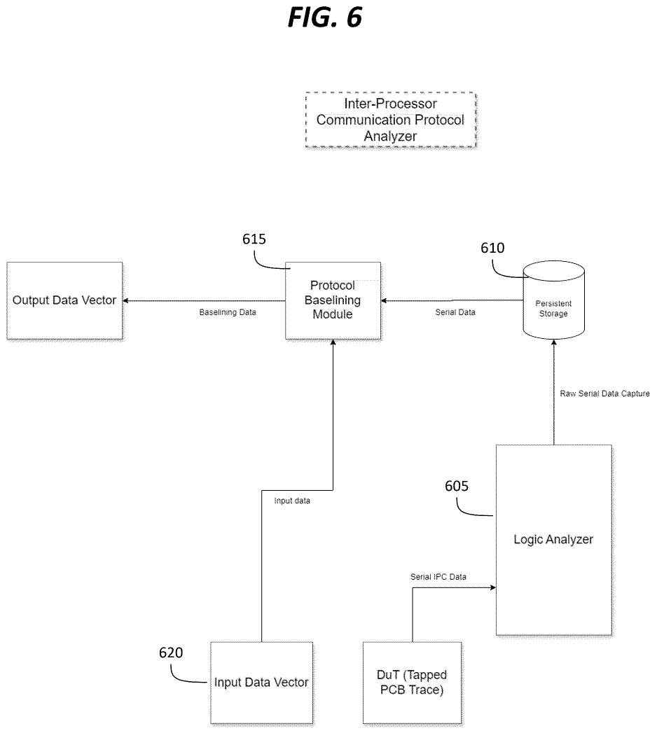

FIG. 5 provides another example flowchart of a method 500 for performing fuzz testing on inter-processor communications. As illustrated in FIG. 5, messages intercepted on the tapped trace may be analyzed by the protocol analyzer software 135 to determine baseline communications data representing standard messages sent to the second electronic processor 115 from the first electronic processor 110. FIG. 6 provides a flowchart of the functionality performed by the protocol analyzer software 135. As represented in FIG. 6, messages intercepted on the tapped trace are analyzed by a logic analyzer 605. The logic analyzer 605 may be a software component of the protocol analyzer software 135. When the logic analyzer 605 is executed by the third electronic processor 120, the logic analyzer 605 may decode the message protocol and translate the intercepted message into a human readable medium. In some implementations, the logic analyzer 605 may be an electronic device that is included in or communicatively connected to the testing device 105 and is configured to decode the message protocol and translate the intercepted message into a human readable medium. As represented by block 610, the third electronic processor 120 may store the human readable messages in the memory 125 or a remote database. At block 615, the third electronic processor 120 may utilize the human readable messages to determine baseline communications data. At block 615, the third electronic processor 120 may also utilize a file or input data vector (represented by block 620) received from, or created based on data received from, a remote server. The input data vector may include an indication of what fields included in a message are important, human readable labels associated with files, what protocol (for example, serial peripheral interface (SPI) protocol, inter-integrated circuit (I2C) protocol, or another protocol) is being used by the first electronic processor 110 to communicate with the second electronic processor 115, and, in some cases other indications.

In some implementations, to determine baseline communications data, the third electronic processor 120 utilizes basic statistic methodologies such as determining the standard deviation of data within the structure of the physical communication interface protocol that is used for communication between the electronic processors being tested. Finding the standard deviation of various data bytes within the communication protocol as well as the mean value provides a baseline that future messages transmitted via the trace may be compared to determine whether the messages should be flagged as or determined to be anomalous behavior.

In other implementations, to determine baseline communications data, the third electronic processor 120 utilizes a machine learning model (for example, a neural network or a classification model) that is built and trained using messages intercepted during normal operation (prior to active fuzzing or injecting fuzzed messages). During active fuzzing, the machine learning model may be used to determine if the message data sent via the hardware trace directly after the injection of a fuzzed message is anomalous or adheres to the established baseline communications data.

Returning to FIG. 4, at block 415, based on the baseline communications data, the third electronic processor 120 generates a fuzzed message. In some implementations, the third electronic processor 120 also utilizes user input data to generate the fuzzed message. The user input data may include protocol and trace information from logic analysis, operation codes (opcodes) that indicate what type of data is being transferred or communicated from the first electronic processor 110 to the second electronic processor 115, and data layout/format of messages transmitted from first electronic processor 110 to the second electronic processor 115.

The fuzzed message includes random, purposely corrupt, large amounts of data, or information designed to cause the second electronic processor 115 to malfunction. For example, fuzzed data may include data of an improper type or size and cause an electronic device (for example, the second electronic processor 115) to perform an operation that results in an error or an exception. An unhandled error or exception may cause the software of the second electronic processor 115 or the chip to malfunction and give a bad actor an opportunity to manipulate that complete working system implemented on the PCB. What data is of an improper type or size may be determined based on the baseline communications data.

At block 420, the third electronic processor 120 sends the fuzzed message to the second electronic processor 115. In some implementations, as illustrated in FIG. 5, sending the fuzzed message to the second electronic processor 115, includes the third electronic processor 120 executing a protocol signal generator 505 to convert the fuzzed message to a signal that adheres to the communication protocol utilized by the first electronic processor 110 to communicate with the second electronic processor 115 and vice-versa. In some implementations, the third electronic processor 120 may also execute the protocol signal generator 505 to determine which tapped trace to use to send the fuzzed message.

In some implementations, the third electronic processor 120 is configured to determine whether the fuzzed message caused the second electronic processor 115 to malfunction. For example, the third electronic processor 120 may execute the protocol signal generator 505 to analyze instrumentation feedback to determine whether the fuzzed message caused the second electronic processor 115 to malfunction. The process of determining whether the second electronic processor 115 is malfunctioning due to a fuzzed message may be referred to as an “instrumentation check.”

An instrumentation check may be performed by determining messages transmitted after injection of a fuzzed message and compare the messages to the baseline communication data. By comparing messages transmitted after a fuzzed message is injected to baseline communication data, it may be determined whether the fuzzed message caused the second electronic processor 115 to enter a state in which it can no longer function normally and send normal chip-to-chip communications. In some implementations, the instrumentation check is a health check of an aspect of the complete working system implemented on the PCB that the second electronic processor 115 is responsible for, and failure of the health check constitutes an indicator-of-compromise or sign of a failure to be robust under adverse conditions.

In one example, to uncover issues with the chip-to-chip communication or uncover potential security vulnerabilities that warrant further investigation, the third electronic processor 120 may measure data transmission from the second electronic processor 115. For example, the third electronic processor 120 may measure the data transmitted from another communication interface (one other than the one used to receive the fuzzed message) controlled by the second electronic processor 115 (for instance a controller area network (CAN) transceiver or ethernet switch) that relies on communication from the first electronic processor 110 to function normally or in a standard operating mode. When data transmission measured on the communication interface exposed externally to the PCB traces deviates from the data transmission that is expected (for example, when the communication interface does not continuously transmit data when it is expected to continuously transmit data, when the communication interface does not transmit data at an expected interval, or when the communication interface does not transmit data when a triggering of data transmission is expected), the third electronic processor 120 may determine that the second electronic processor 115 is malfunctioning or deviating from its standard operating mode due to the injected fuzzed message. This method of detecting anomalous events or malfunctioning of the second electronic processor 115 during fuzzing may be achieved indirectly, via the instrumentation of the application or service that is running on the hardware chips (the first electronic processor 110 and the second electronic processor 115) that are in communication within the complete system (the other components included on the PCB).

In another example, an anomalous event or malfunctioning of the second electronic processor 115 may be detected by measuring the amperage draw of the second electronic processor 115 during the fuzz testing. Every chip (electronic processor) on a PCB must be directly or indirectly powered to function properly and, therefore, requires a grounding connection and a connection to a physical trace that is supplied with current from a power source. These two connections are commonly referred to as voltage at the common collector (VCC) and ground (GND). There are corresponding VCC and GND pins on each electronic processor included on the PCB. Prior to actively fuzzing, the amount of amperage utilized by the second electronic processor 115 may be measured by attaching to these pins and measuring the current (commonly measured in amperes) running through them. Most chips will draw the same or a similar amount of current under normal operation or when not required to complete intensive computation tasks. However, if the state of processing on a chip is changed due to receipt of a fuzzed message, the current draw of the chip may increase or decrease depending on what anomaly or error was caused or triggered by the fuzzed message. When the current draw of the second electronic processor 115 is outside of an expected range, the third electronic processor 120 may determine that the second electronic processor 115 has malfunctioned due to a fuzzed message. The expected range may be determined prior to active fuzz testing.

In some implementations, when the third electronic processor 120 determines that the fuzzed message caused the second electronic processor to malfunction, the third electronic processor 120 generates an alert. For example, the testing device 105 may include an output device (for example, a speaker, an LED screen, LCD screen, a combination of the foregoing). In some implementations, the alert includes a recommendation to perform a hardware modification (for example, a recommendation to add a hardware security module between the first electronic processor 110 and the second electronic processor 115 to encrypt communications between the first electronic processor 110 and the second electronic processor 115) or a software modification (for example, programming the second electronic processor 115 to handle an exception caused by the fuzzed message).

Thus, the implementations described herein provide, among other things, a system and a method for performing fuzz testing on inter-processor communications. Various features and advantages of the implementations are set forth in the following claims.

What is claimed is:

1. A system for performing fuzz testing on inter-processor communications, the system comprising:
a first electronic processor;
a second electronic processor configured to communicate with the first electronic processor; and
a testing device, connected to the first electronic processor and the second electronic processor and including a third electronic processor, the third electronic processor configured to:
intercept messages from the first electronic processor, the messages sent by the first electronic processor to the second electronic processor;
determine, based on the messages, baseline communications data representing standard messages sent to the second electronic processor from the first electronic processor;
based on the baseline communications data, generate a fuzzed message; and
send the fuzzed message to the second electronic processor.

2. The system according to claim 1, the third electronic processor further configured to:
determine whether the fuzzed message caused the second electronic processor to malfunction; and
when the fuzzed message caused the second electronic processor to malfunction, generate an alert.

3. The system according to claim 2, wherein the third electronic processor further configured to determine whether the fuzzed message caused the second electronic processor to malfunction by measuring amperage draw of the second electronic processor.

4. The system according to claim 2, wherein the third electronic processor further configured to determine whether the fuzzed message caused the second electronic processor to malfunction by measuring data transmission from the second electronic processor.

5. The system according to claim 1, wherein the first electronic processor and the second electronic processor are included on a printed circuit board and the printed circuit board is designed such that the first electronic processor and the second electronic processor are communicatively connected via a hardware trace.

6. The system according to claim 5, wherein the testing device is inserted between the first electronic processor and the second electronic processor via a shunt inserted when the hardware trace is broken.

7. The system according to claim 2, wherein the alert includes a recommendation to perform a hardware modification or a software modification.

8. The system according to claim 1, wherein the third electronic processor is configured to determine, based on the messages, baseline communications data representing standard messages sent to the second electronic processor from the first electronic processor by executing a logic analyzer and a machine learning model.

9. A method for performing fuzz testing on inter-processor communications, the method comprising:
intercepting messages from a first electronic processor, the messages sent by the first electronic processor to a second electronic processor;
determining, based on the messages, baseline communications data representing standard messages sent to the second electronic processor from the first electronic processor;
based on the baseline communications data, generating a fuzzed message; and
sending the fuzzed message to the second electronic processor.

10. The method according to claim 9, the method further comprising:
determining whether the fuzzed message caused the second electronic processor to malfunction; and
when the fuzzed message caused the second electronic processor to malfunction, generating an alert.

11. The method according to claim 10, wherein determining whether the fuzzed message caused the second electronic processor to malfunction includes measuring amperage draw of the second electronic processor.

12. The method according to claim 10, wherein determining whether the fuzzed message caused the second electronic processor to malfunction includes measuring data transmission from the second electronic processor.

13. The method according to claim 10, wherein the first electronic processor and the second electronic processor are included on a printed circuit board and the printed circuit board is designed such that the first electronic processor and the second electronic processor are communicatively connected via a hardware trace.

14. The method according to claim 13, wherein a testing device is inserted between the first electronic processor and the second electronic processor via a shunt inserted when the hardware trace is broken.

15. The method according to claim 10, wherein the alert includes a recommendation to perform a hardware modification or a software modification.

16. The method according to claim 9, wherein determining, based on the messages, baseline communications data representing standard messages sent to the second electronic processor from the first electronic processor includes executing a logic analyzer and a machine learning model.
